(19) United States
(12) Patent Application Publication
(10) Pub. No.: US 2010/0117039 A1
(43) Pub. Date: May 13, 2010

(54) Inflatable structure for use in an inflatable lifting device and an inflatable lifting device incorporating two or more such structures

(75) Inventors: Dan Perrett, Abergavenny (GB); Austin William Owens, Leominster (GB)

Correspondence Address: CHERNOFF, VILHAUER, MCCLUNG & STENZEL, LLP, 601 SW Second Avenue, Suite 1600, PORTLAND, OR, 97204-3157, US

(73) Assignee: Mangar International (Holdings) Ltd., Presteigne (GB)

(21) Appl. No.: 12/584,484

(22) Filed: Sep. 4, 2009

(30) Foreign Application Priority Data
Sep. 9, 2008 (GB) 0816408.9

(51) Int. Cl. B66F 3/35

(52) U.S. Cl. 254/93 HP

(57) ABSTRACT

An inflatable structure 12 has at least two internal webs 18 extending between upper and lower surfaces 20, 22. The webs are angled to create a different profile on the upper surface 20 from that of the lower surface 22 when the structure is inflated. The structure 12 may form part of a lifting device 10 in which a number of such structures are stacked one on top of another so that the profile on the upper surface 20 of each lower structure nests with the profile of the lower surface 22 of an adjacent upper structure. This increases the contacting surface area between adjacent structures, reducing deflection when the stack is subjected to a load. The webs 18 can be arranged to form at least one ridge in one of the upper and lower surfaces and at least one trough in the other of the upper and lower surfaces opposite the ridge.

### TECHNICAL FIELD OF THE INVENTION

This patent application relates to an inflatable structure for use in an inflatable lifting device of the type made up of a series of such stacked inflatable structures that can be sequentially inflated to elevate a load. The application also relates to an inflatable lifting device comprising two or more such structures.

Inflatable lifting devices of the type to which the present invention is directed must be capable of stably supporting a load, such as a disabled or infirm person, as the structures are inflated and/or deflated in order to dynamically raise and lower the load. The requirements of a dynamic inflatable lifting device, and the structures which make up the device, are very different from static inflatable supports such as inflatable mattresses, lilos and the like. Static inflatable supports of this type are generally designed to support a load only when fully inflated and are not considered suitable for use in dynamically raising or lowering a load in a safe and controlled manner.

### BACKGROUND TO THE INVENTION

It is known, for example from GB 2 296 941 A and WO 2005/058222 A2, to produce inflatable lifting devices comprising a stack of generally rectangular inflatable structures. The upper and lower surfaces of each structure are interconnected by vertically aligned internal webs to create nominally horizontal upper and lower surfaces. The surfaces are in fact corrugated as the material is restrained by the webs but bulges outwardly in between the webs to form ridges. When identical structures are stacked one on the other, point contact is made by the ridges in the lower surface of an upper structure resting on the ridges in the upper surface of a lower structure. When the stack is loaded, the ridges are depressed until, at a given internal pressure, there is sufficient contact area to transmit the load from the upper to the lower structure. When multiple structures are stacked on top of each other to make a lifting device, the cumulative effect of these depressions can lead to a deflection of the upper surface of the stack, when loaded, which is unacceptable.

It is also known to form a lifting device comprising tubular ring-like inflatable structures. Such an arrangement is shown for example in the applicant's co-pending application GB2428564 A. In this arrangement, there is point contact between each tube in the stack and its neighbour which gives rise to similar problems to those discussed above as the tubes are depressed when the device is loaded. FIG. 8a of the accompanying drawings illustrates this problem and shows in cross section two inflated tubular structures 1, 2 one on top of the other. If the assembly is loaded, the tubes deflect by a distance d until a contact area A sufficient to transmit the load from the upper to the lower tube is achieved. In a stack of n structures, the total deflection D will be d(n−1).

A method of joining tubular structures in a stack to overcome this problem is disclosed in GB2428564 A and is illustrated in FIG. 8b of the accompanying drawings. In this method, the tubular structures 3, 4, are welded together to create a membrane 5 that is common to both the upper and lower structures. The area A of this common membrane is large enough that, once inflated to a given a given pressure, the desired load can be supported with a minimum of deflection. The drawback to this method is that all the structures need to be permanently joined to each other such that if one is damaged the complete assembly must be scrapped.

There is a need therefore for an improved inflatable lifting device which overcomes or at least mitigates some or all of the drawbacks of the prior art. There is also a need for an improved inflatable structure which can be used together with other similar structures to form such an improved lifting device.

### SUMMARY OF THE INVENTION

In accordance with a first aspect of the invention, there is provided an inflatable structure for use in a lifting device comprising a plurality of stacked structures, the structure having at least two internal webs extending between an upper and lower surface, in which the webs are configured so as to create a different profile on the upper surface from that of the lower surface when the structure is inflated.

When structures in accordance with the invention are stacked together to form a lifting device, the upper surface of a lower structure nests within the profile of the lower surface of a structure positioned above it in the stack. This increases the surface area over which adjacent structures contact one another, enabling the device to carry a load with a reduced deflection when compared with the prior art arrangements at a given internal pressure.

The webs may be arranged so that when the structure is inflated, at least one ridge is formed in one of the upper and lower surfaces and at least one trough is formed in the other of the upper and lower surfaces opposite the ridge.

At least two of the internal webs may be arranged so as to extend between the upper and lower surfaces at an angle to one another. The at least two of the internal webs may be arranged so as to diverge from one another across the structure when it is inflated such that a ridge is produced in one of the upper and lower surfaces between the webs at their widest end whilst a trough is produced in the other of the upper and lower surfaces opposite from the ridge. The webs may be spaced apart at their narrowest end such that a smaller ridge is produced at the base of the trough when the structure is inflated.

The structure may comprise one or more generally tubular sections and there may be two internal webs arranged to extend divergently between the upper and lower surfaces of at least one of the sections when the structure is inflated.

The structure may be generally rectangular in shape having a depth which is less than its length and its width, the structure having three or more internal webs arranged such that when inflated, two or more ridges are produced in one of the upper and lower surfaces with a corresponding number of troughs being produced in the other of the upper and lower surfaces, each trough being aligned opposite a respective ridges.

There may be an even number of internal webs arranged in divergent pairs.

The structure may comprise a number of interconnected inflatable sections in which at least one of the sections comprises at least two internal webs extending between an upper and lower surface, the webs being configured so as to create a different profile on the upper surface of the section from that of the lower surface of the section when the structure is inflated.

The structure may comprise two elongate sections aligned generally parallel to one another in spaced relation, the two elongate sections being interconnected at or close to either end by an inflatable cross member to form a generally rectilinear ring-like structure, in which each of the elongate sections comprises at least two internal webs extending between an upper and lower surface, the webs being configured so as to create a different profile on the upper surface of the elongate section from that of the lower surface when the structure is inflated. The two elongate sections may also be interconnected by means of a further inflatable cross member at a position between their ends to form a generally rectilinear figure of 8.

In accordance with a second aspect of the invention there is provided an inflatable lifting device comprising at least two structures in accordance with the first aspect of the invention stacked one on top of another, the arrangement being such that at least one region of the upper surface of a lower one of the structures nests within a corresponding region of the lower surface of another of the structures when the device is inflated.

Each of the structures may have internal webs arranged so that when the structure is inflated, at least one ridge is formed in an upper surface and at least one trough is formed in a lower surface opposite the ridge.

The structures may be arranged in the stack so that the, or each, ridge formed in the upper surface of each of the structures below the uppermost structure engages in a trough in the lower surface of a structure positioned above it in the stack.

### DETAILED DESCRIPTION OF THE INVENTION

Several embodiments of the invention will now be described, by way of example only, with reference to the remaining drawings in which:

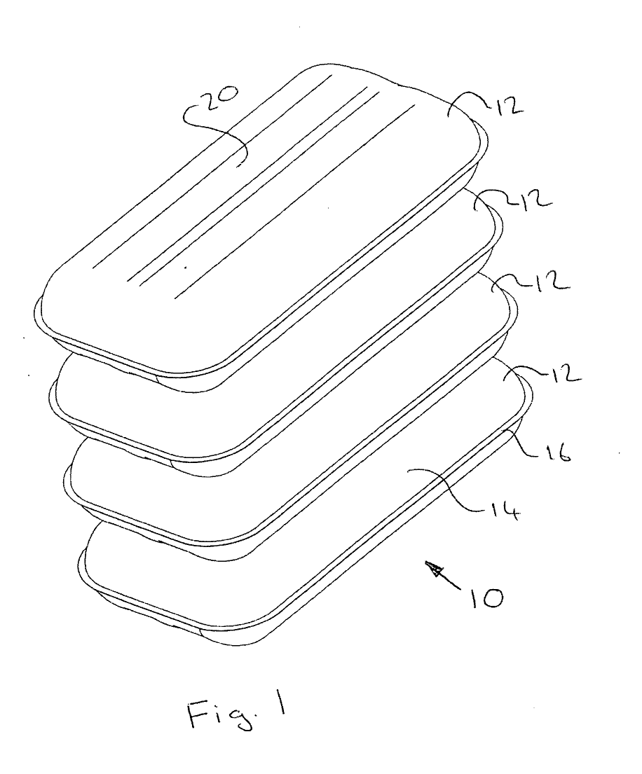

FIG. 1 is a perspective view of an inflatable lifting device comprising a number of inflatable structures in accordance with the invention stacked one upon another;

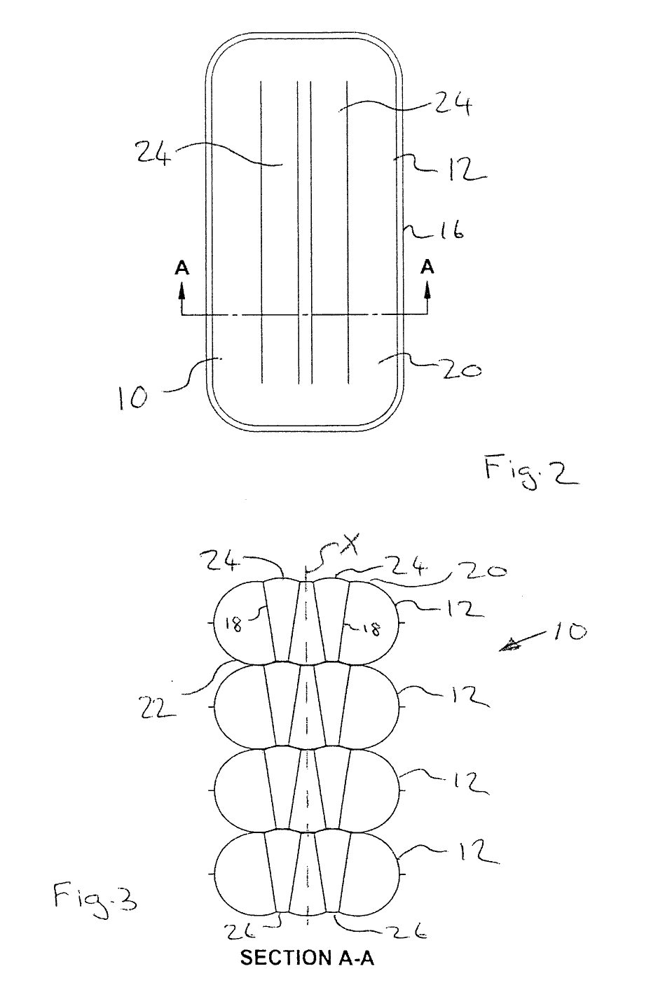

FIG. 2 is a plan view of the lifting device of FIG. 1;

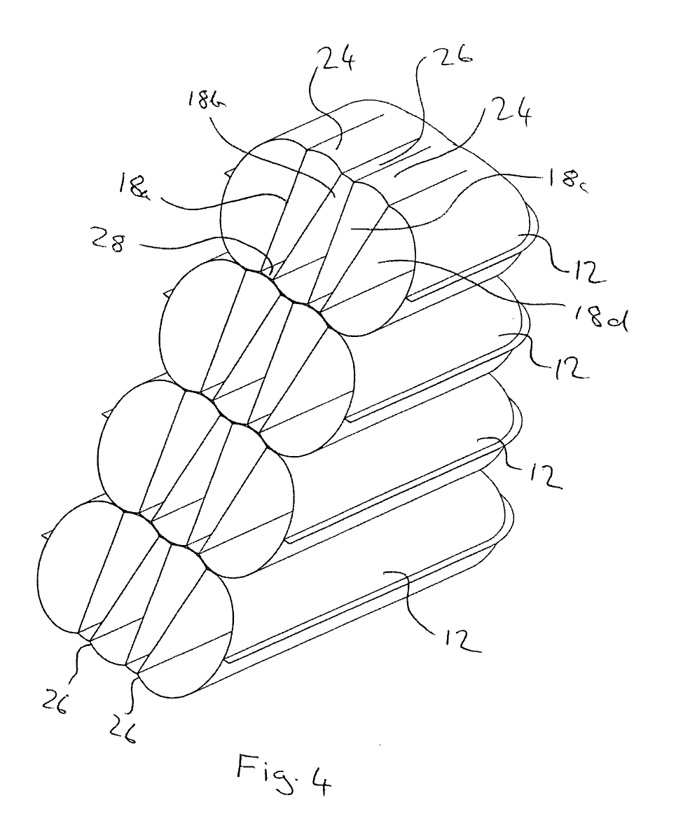

FIG. 3 is a cross sectional view through the lifting device of FIGS. 1 and 2 taken on line A-A of FIG. 2;

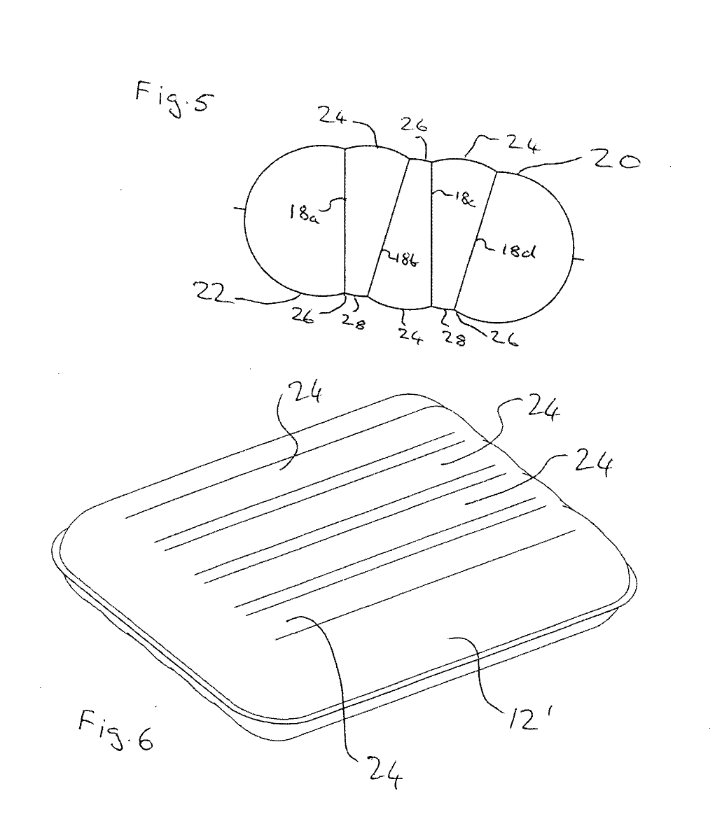

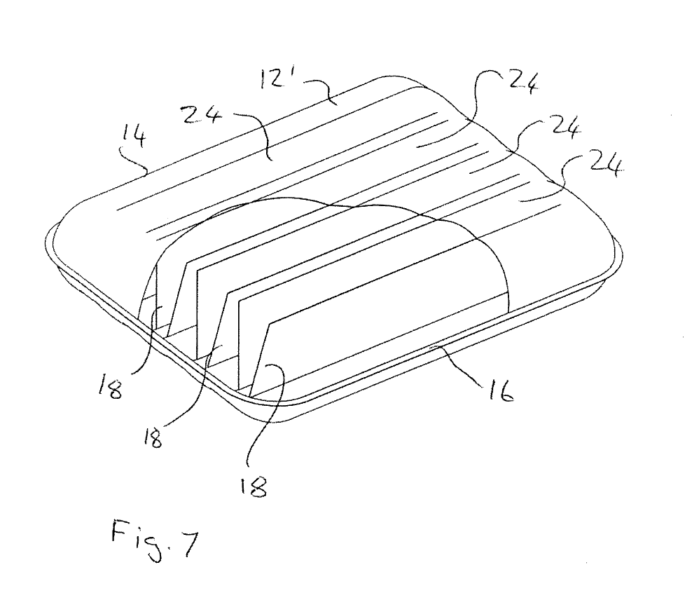

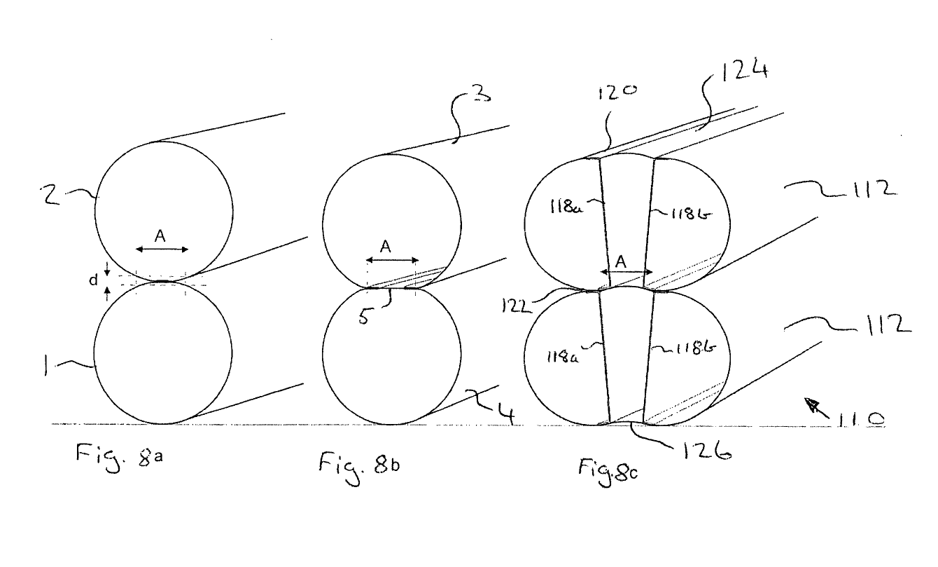

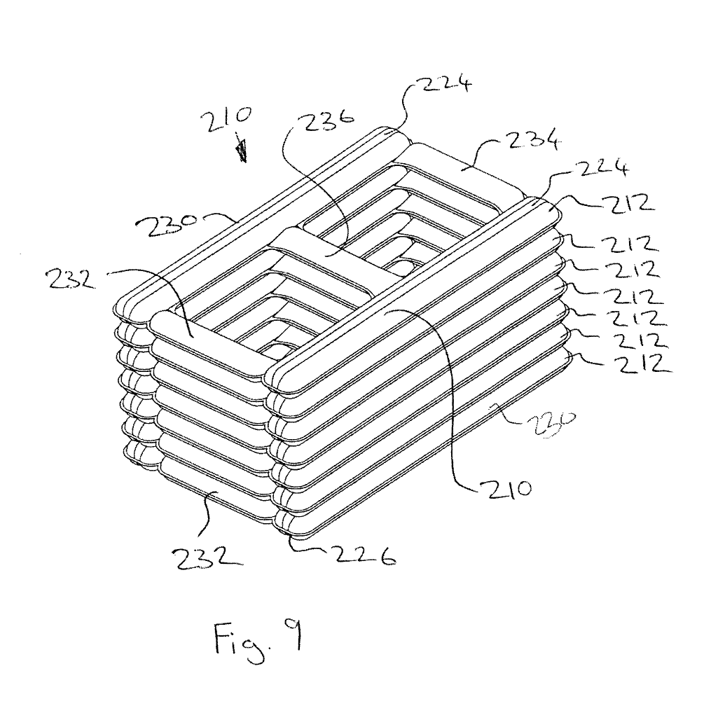

FIG. 4 is a cut-away perspective view the lifting device of FIGS. 1 to 3;

FIG. 5 is a cross-sectional view through one of the structures forming the lifting device of FIG. 1 on an enlarged scale;

FIG. 6 is a perspective view of an inflatable structure for use in an inflatable lifting device in accordance with a second embodiment of the invention;

FIG. 7 is a view similar to that of FIG. 6 but with part of the outer casing material removed to show the internal webs;

FIG. 8c is a cross-sectioned perspective view of part of a lifting device in accordance with a third embodiment of the invention; and

FIG. 9 is a perspective view of a further embodiment of an inflatable lifting device in accordance with the invention.

With reference to FIGS. 1 to 5, a first embodiment of a lifting device 10 in accordance with the invention comprises a plurality of inflatable structures 12 stacked one on top of another. In the present embodiment, there are four structures in the stack but the number of structures 12 can be varied as required to give the desired range of lift. Each structure 12 is separable from the others in the stack and can be inflated independently using a pressurised fluid such as air.

In use, a required number of un-inflated structures 12 are formed into a stack 10 and inflated sequentially, starting with the lowest structure and working towards the uppermost structure. Although not shown in the drawings, the structures 12 will usually be secured together in the stack using mechanical fasteners in a manner known in the art.

Each of the structures 12 in the present embodiment are generally rectangular in shape, though with rounded corners, and have a depth that is significantly less that its width and length. The outer casing 14 is formed by means of two sheets of material that are joined together by means of a fin seal 16. However, the outer casing can be produced in any suitable way. Although not shown in the drawings, each structure 12 has a valve arrangement through which a pressurised fluid can be admitted into the interior to inflate the structure. Means for releasing the pressurised fluid from the structure will also be provided. This may be integral with the inlet valve or separate.

Each structure 12 has a number of internal webs 18 that extend longitudinally over the majority of the length of the structure and which interconnect the upper 20 and lower 22 surfaces of the structure. The internal webs 18 restrain outward movement of the upper and lower surfaces as the structure is inflated so that the upper and lower surfaces remain nominally horizontal (that is to say nominally parallel to a surface on which the device is placed).

In accordance with the invention, the internal webs 18 are arranged so that the profile of the upper surface 20 is different from that of the lower surface such that regions of the upper surface of one structure are able to nest within corresponding regions of the lower surface of another structure 12. This increases the surface contact area between the structures, enabling the device 10 to carry a desired load with minimal, or at least acceptable, deflection. A further advantage of this nesting is that it gives an initial locating means for one structure relative to its neighbour.

The differing profiles of the upper and lower surfaces 20, 22 is achieved by offsetting the position at which each web 18 is connected with the upper surface 20 relative to the position at which it is connected with the lower surface 22. As a result, when the structure 12 is inflated, the webs 18 do not extend perpendicularly between the upper and lower surfaces but are angled relative to a plane (indicated by dashed line X in FIG. 3) taken perpendicularly to the nominal horizontal planes of the upper and lower surfaces. This results in a series of longitudinal ridges 24 and troughs 26 being produced on the upper and lower surfaces 20, 22, with the ridges 24 on the upper surface being offset from the ridges 24 on the lower surface. By appropriate positioning of the webs 18, it can be arranged that the ridges 24 formed in the upper surface 20 of one structure 12 align with and nest in the troughs 26 formed in the lower surface of another one of the structures when the outer peripheries of the structures are aligned.

In the present embodiment, there are four internal webs 18 arranged in two pairs 18a, 18b and 18c, 18d, with the webs in each pair diverging in a direction from the lower surface 22 towards the upper surface 20. This results in a ridge 24 being formed in the upper surface 20 between the webs 18 in each pair where they are at their widest and a trough 26 being formed in the lower surface 22 opposite the ridge 24 where the webs in each pair are at their narrowest. In the present embodiment, the webs 18a, 18b and 18c, 18d in each pair are spaced apart slightly at there narrowest where they connect with the lower surface 22. This allows the material of the lower surface between the webs to bulge outwardly when the structure is inflated to produce a small ridge 28 at the base of each of the troughs 26. By careful positioning, it can be arranged that the tops of the ridges 24 in the upper surface of one structure 12 contact the smaller ridges 28 in the lower surfaces of a further structure 12 placed on top of it to further increase the contact area between the structures. However, the webs in each pair need not be spaced at their narrowest point or need only be spaced by a small amount if desired.

FIGS. 6 and 7 show a second embodiment of a structure 12′ in accordance with the invention and which can be combined with other similar structures to form an inflatable lifting device 10. The structure 12′ is similar to the structure 12 described above in relation to the first embodiment except that it is wider and has eight internal webs 18 arranged in four divergent pairs. This provides four ridges 24 on the upper surface 20 and a corresponding number of troughs in the lower surface.

The generally rectangular nesting shapes described above may form part or parts of a more complicated structure. Not all elements of the complex structure need be constructed in accordance with the present invention to provided nesting upper and lower surfaces. For example, FIG. 8c shows part of a third embodiment of an inflatable lifting device 110 in accordance with the invention. In this embodiment, each structure 112 has a number of generally tubular sections linked to form a rectangular, ring-like shape, similar to the structures shown in GB 2 428 564 A. At least one of the tubular sections in each structure has two internal webs 118a, 118b that diverge from lower surface 122 towards the upper surface 120. This produces a single ridge 124 in the upper surface and a single trough 126 in the lower surface opposite the ridge. When two or more structures 112 are stacked, the ridge 124 in the upper surface of a lower structure nests within the trough 126 in the lower surface of a structure 112 positioned above it in the stack. If desired, more than two internal webs can be provided any one section such that more than one ridge and more than one trough is formed on the upper and lower surfaces. Furthermore, the webs could be reversed so as to provide a ridge on the lower surface and corresponding trough on the upper surface if desired.

FIG. 9 illustrates a further embodiment of a lifting device 210 comprising a stack of complex inflatable structures 212. Each structure 212 is made up of a number of generally tubular sections connected together form a generally rectangular “figure of 8” shape.

Each of the structures 212 comprises two generally tubular, elongate longitudinal sections 230 aligned parallel to one another but spaced apart. The two longitudinal sections 230 are interconnected at either end by an inflatable cross member 232, 234 to form a rectilinear ring-like structure. A third inflatable cross member 236 interconnects the two longitudinal sections 230 at a position between their ends so that the resulting structure has a rectilinear figure of 8 shape. In an alternative embodiment, the third cross member 236 could be omitted so that the structure has a ring-like shape similar to that discussed above in relation to FIG. 8c.

The longitudinal sections 230 and the cross members 232, 234, 236 are interconnected internally by means of ports (not shown) to allow air (or other pressurised fluid) to flow through the whole structure from a single inflation point. As shown in FIG. 9, a number of the structures 212 can be stacked one on top of another to provide a lifting device 210 having the desired range of lift. As with the previous embodiments, the structures 212 are inflated sequentially to effect lift.

Each of the longitudinal sections 230 are constructed in a similar manner to the tubular sections 112 described above with reference to FIG. 8c, with divergent longitudinal internal webs 118a, 118b arranged so that when the structure 212 is inflated, a ridge 224 is formed along the upper surface of the longitudinal sections 230 and a corresponding trough 226 is produced in the lower surface opposite the ridge. When the structures 212 are formed into a stack and inflated, the ridges 224 on the upper surfaces of the longitudinal sections 230 in each of the structures 212 below the uppermost structure engage in the troughs 226 in the lower surface of the corresponding longitudinal sections of the structure 212 positioned above it in the stack.

In the present embodiment, only the longitudinal sections 230 are provided with internal webs arranged to produce a ridge 224 on the upper surface and a corresponding trough 226 in the lower surface. In practice this has been found to be sufficient to enable the device 210 to take a given load with an acceptable amount of deflection. However, if desired, some or all of the cross members 232-236 could also be provided with internal webs 118a, 118b so that they also have corresponding ridges 224 and troughs 226 on their upper and lower surfaces when inflated. It should also be noted that the web arrangement can be reversed so that ridges are formed in the lower surfaces of the sections and corresponding troughs in the upper surfaces.

As illustrated in the embodiment shown in FIG. 9, where an inflatable structure comprises a number sections, not all the sections need have differing upper and lower surface profiles to allow nesting, provided that the total surface area over which adjacent structures in the stack contact one another is sufficient to enable the device to carry a desired load with an acceptable deflection at a given internal pressure.

Where an inflatable structure in accordance with the invention is made up of two or more sections, the sections can be of any shape and need not be tubular. For example, two or more generally rectangular sections, each being similar to the structures 12, 12′ described above, can be combined together to form a single inflatable structure for use in a lifting device. Furthermore, whilst structures having a rectilinear ring-like or figure of 8 form have been found to be particularly useful, inflatable structures in accordance with the invention can have any suitable shape.

In order to produce a ridge 24, 124, 224 on one surface of an inflatable structure opposite a corresponding trough 26, 126, 226 on an opposing surface, it is generally necessary to have at least two internal webs 18, 118 which extend divergently between the surfaces. However, there is no upper limit to the number of internal webs that can be used. Furthermore, whilst it is convenient to have the internal webs arranged in pairs to provide a stable bottom surface, this is not essential.

Because the structures 12, 12′, 112, 230 in accordance with the invention are not permanently joined together when stacked to form a lifting device, the device can be configured to give a desired range of lift by adding or subtracting structures as required. In addition, damage to one structure can be remedied by changing that structure only rather than scrapping the whole assembly.

The foregoing embodiments are not intended to limit the scope of protection afforded by the claims, but rather to describe examples as to how the invention may be put into practice. For example, whilst the webs in the present embodiments have been configured to produce corresponding ridges and troughs in the upper and lower surfaces, other nesting profiles could also be produced.

What is claimed:

1. An inflatable structure for use in a lifting device comprising a plurality of stacked structures, the structure having an upper and a lower surface and at least two internal webs extending between the upper and lower surfaces, in which the webs are configured so as to create a different profile on the upper surface from that of the lower surface when the structure is inflated.

2. An inflatable structure as claimed in claim 1, in which the webs are arranged so that when the structure is inflated, at least one ridge is formed in one of the upper and lower surfaces and at least one trough is formed in the other of the upper and lower surfaces opposite the ridge.

3. An inflatable structure as claimed in claim 2, in which at least two of the internal webs are arranged so as to extend between the upper and lower surfaces at an angle to one another when the structure is inflated.

4. An inflatable structure as claimed in claim 3, in which the at least two of the internal webs are arranged so as to diverge from one another across the structure when it is inflated, such that a ridge is produced in one of the upper and lower surfaces between the webs at their widest end whilst a trough is produced in the other of the upper and lower surfaces opposite from the ridge.

5. An inflatable structure as claimed in claim 4, in which the webs are spaced apart at their narrowest end such that a smaller ridge is produced at the base of the trough when the structure is inflated.

6. An inflatable structure as claimed in claim 4, in which the structure comprises one or more generally tubular sections, at least one generally tubular section having two internal webs arranged to extend divergently between the upper and lower surfaces when the structure is inflated.

7. An inflatable structure as claimed in claim 1, in which the structure is generally rectangular in shape having a depth which is less than its length and its width, the structure having three or more internal webs arranged such that when inflated, two or more ridges are produced in one of the upper and lower surfaces with a corresponding number of troughs being produced in the other of the upper and lower surfaces opposite respective ridges.

8. An inflatable structure as claimed in claim 7, in which there are an even number of internal webs arranged in divergent pairs.

9. An inflatable structure as claimed in claim 1, the structure comprising a number of inflatable sections, in which at least one section comprises two or more internal webs extending between an upper and a lower surface of the section, the webs being configured so as to create a different profile on the upper surface of the section from that of the lower surface when the structure is inflated.

10. An inflatable structure as claimed in claim 9, in which the structure comprises two elongate sections aligned generally parallel to one another in spaced relation, the two elongate sections being interconnected at or close to either end by a respective inflatable cross member to from a generally rectilinear, ring-like structure, in which each elongate section comprises two or more internal webs extending between an upper and a lower surface of the section, the webs being configured so as to create a different profile on the upper surface of the section from that of the lower surface when the structure is inflated.

11. An inflatable structure as claimed in claim 10, in which the two elongate sections are interconnected by means of a further inflatable cross member at a position between their ends to form a generally rectilinear figure of 8.

12. An inflatable lifting device comprising at least two inflatable structures as claimed in any one of the previous claims stacked one on top of the other.

13. An inflatable lifting device as claimed in claim 12, in which each of the structures comprises internal webs arranged so that when the structure is inflated, at least one ridge is formed on an upper surface of the structure and at least one trough is formed in a lower surface of the structure opposite the ridge.

14. An inflatable lifting device as claimed in claim 13, in which the structures are arranged in the stack so that the, or each, ridge formed in the upper surface of each of the structures below the uppermost structure engages in a trough in the lower surface of a structure positioned above it in the stack.
